(19) United States
(12) Patent Application Publication
(10) Pub. No.: US 2005/0263450 A1
(43) Pub. Date: Dec. 1, 2005

(54) Removable submersible pump filter

(76) Inventor: Henry E. McGrew JR., Bossier City, LA (US)

Correspondence Address: John M. Harrison, 2139 E. Bert Kouns, Shreveport, LA, 71105, US

(21) Appl. No.: 11/137,194

(22) Filed: May 25, 2005

Related U.S. Application Data
(60) Provisional application No. 60/574,981, filed on May 28, 2004.

(51) Int. Cl. B01D 35/26

(52) U.S. Cl. 210/416.1

(57) ABSTRACT

A removable submersible pump filter is characterized in a preferred embodiment by a cylindrical screen having a selected mesh size and sized to fit over the pump housing of a submersible pump and motor combination. A pair of typically plastic split screen collars are fitted to the top and bottom of the screen and may be provided with collar openings and a collar bolt and nut, respectively, for removably tightening and securing the screen and the split collars on the pump housing. Alternatively, the resiliency of the split screen collars provide sufficient tension to secure the split collars and the screen on the pump housing. A filter medium having selected filtering characteristics may be placed inside the filter screen adjacent to the pump suction openings for filtering water or other liquid flowing into the pump through the suction openings.

This application claims the benefit of and incorporates by reference prior filed copending U.S. Provisional Application Ser. No. 60/574,981, Filed May 28, 2004.

### SUMMARY OF THE INVENTION

This invention relates to submersible pumps and more particularly, to a removable submersible pump filter which is characterized by a cylindrical screen having a selected mesh size and sized to fit over the pump housing of a submersible pump having a pump motor. The screen is removably secured to the pump element of the pump and motor combination at the pump suction openings by means of a pair of typically plastic split collars that fit over the top and bottom of the screen and are secured in place by tension in the resilient collar split ring. Alternatively, the split collar may be provided with collar openings, through which is inserted a collar bolt secured by a nut, respectively. The nut and bolt combinations removably secure the screen and the collars to the pump housing of the submersible pump and motor combination such that the screen covers the pump suction openings. The filter screen has a screen mesh of selected size and is designed to optionally receive a cylindrically-shaped filter medium or a packed filter medium positioned between the filter screen and the pump suction openings for filtering out various materials in the water or other liquid to be pumped, including sand, debris and the like. The removable submersible pump filter can be quickly and easily installed on and removed from the pump of the submersible pump-motor combination by hand pressure in one embodiment, or by loosening and tightening the respective collar bolts.

### BRIEF DESCRIPTION OF THE DRAWINGS

The invention will be better understood by reference to the accompanying drawings, wherein:

FIG. 1 is a perspective view of a preferred embodiment of the removable submersible pump filter of this invention fitted on the pump housing of a submersible pump-motor combination, which pump-motor combination is illustrated in phantom;

FIG. 2 is an exploded view of the removable submersible pump filter with respect to the submersible pump-motor combination illustrated in FIG. 1; and

FIG. 3 is an exploded view of the filter screen and screen collar elements of the filter screen illustrated in FIGS. 1 and 2, more particularly illustrating an optional cylindrically-shaped filter medium sized for insertion inside the filter screen and over the pump suction openings of the pump housing when the filter screen is in place on the pump.

### DESCRIPTION OF THE PREFERRED EMBODIMENTS

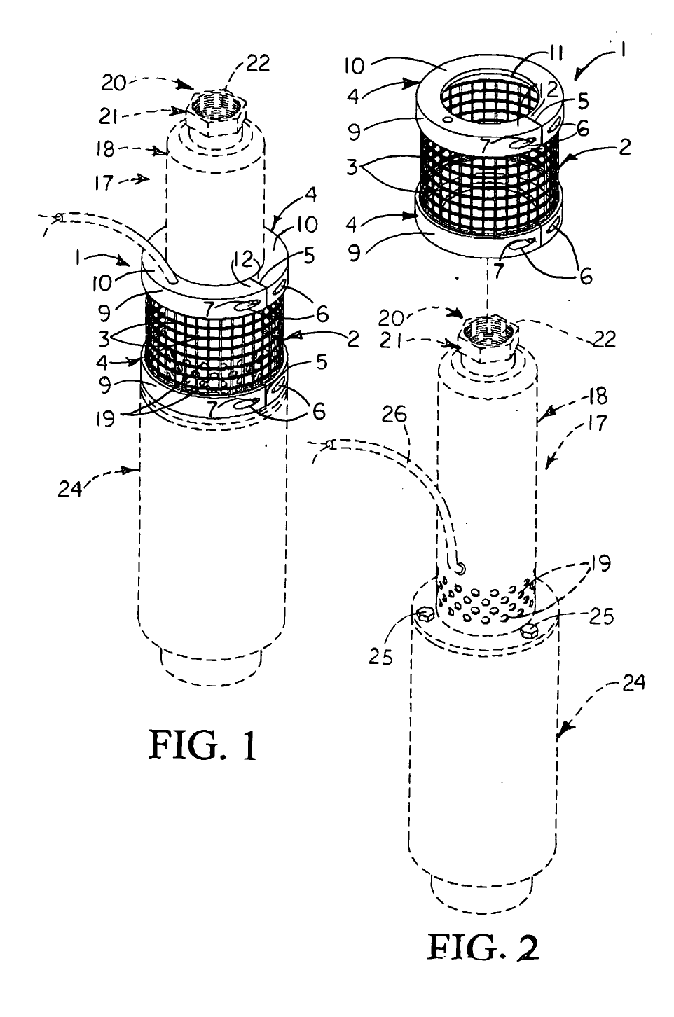

Referring initially to FIGS. 1 and 2 of the drawings, a preferred embodiment of the removable submersible pump filter of this invention is generally illustrated by reference numeral 1 and includes a cylindrical filter screen 2, having a screen mesh 3 of selected size which is designed for filtering water or other liquid in a well in which the removable submersible pump filter 1 is immersed. A pair of round split, typically plastic, screen collars 4 are seated on the top and bottom ends of the filter screen 2 and in a preferred embodiment are fitted with oppositely-disposed, aligned collar openings 6 that receive a collar bolt 7 and a nut 8, respectively, extending through a split line 5 at the matching edges or split ends 12 of the respective screen collars 4. Accordingly, the collar bolts 7 and the companion nuts 8 serve to tighten and loosen the two screen collars 4 on the filter screen 2 to selectively secure the removable submersible pump filter 1 on the pump housing 18 of a submersible pump 17, illustrated in phantom in FIGS. 1 and 2. Alternatively, the typically plastic split screen collars 4 can be shaped from a resilient plastic material having a “memory” for exerting pressure on the filter screen 2 without the necessity of using the collar bolt 7 and nut 8. The submersible pump 17 is typically characterized by multiple, radially-disposed pump suction openings 19 in the pump housing 18 that communicate with a pump discharge 20 at the top end thereof. The pump discharge 20 is typically provided with a pump discharge fitting 21, having discharge fitting threads 22 for receiving a length of pipe and a corresponding fitting (not illustrated) and discharging water or other fluid from the submersible pump 17 in the well upwardly to the surface, according to the knowledge of those skilled in the art.

A pump motor 24 is also illustrated in phantom in FIGS. 1 and 2 and is attached to the bottom end of the pump housing 18, typically by means of pump mount bolts 25. A power cord 26 is fitted to the submersible pump 17 and the pump motor 24 and also extends to the surface for connection to a power source (not illustrated) and supplying power to the pump motor 24 in conventional fashion, further according to the knowledge of those skilled in the art. Accordingly, when the removable submersible pump filter 1 is fitted to the pump housing 18 as illustrated in FIG. 1 of the drawings, the screen mesh 3 of the filter screen 2 encloses the pump suction openings 19 and serves to screen debris, sand and the like, depending upon the size of the screen mesh 3, from the water or other liquid flowing through the screen mesh 3 and into the pump suction openings 19 and from the pump housing 18, through the pump discharge 20.

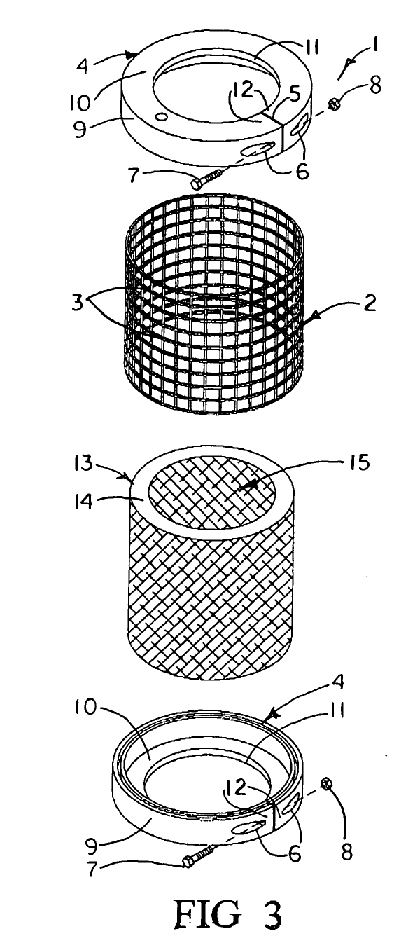

Referring now to FIGS. 1 and 3 of the drawings, in a preferred embodiment of the invention each of the screen collars 4 is characterized by a round collar split ring 9, typically injection-molded from a typical resilient plastic such as polyethylene or polypropylene, in non-exclusive particular. The screen collars 4 each have a collar shoulder 10 for receiving the top and bottom rim respectively, of the filter screen 2, with a shoulder opening 11 provided in the center of the collar shoulder 10 for accommodating the pump housing 18. A pair of aligned collar openings 6 may, if necessary, be provided in the collar split ring 9 of each of the screen collars 4 at a split line 5 to accommodate a collar bolt 7 and a cooperating nut 8, respectively, for selectively securing the split ends 12 together at the split line 5 and mounting the filter screen 2 on the pump housing 18, as illustrated in FIG. 1. In another preferred embodiment of the invention a cylindrically-shaped filter medium 13 may be fitted inside the filter screen 2 and seated against the pump suction openings 19 in the pump housing 18 of the submersible pump 17, as illustrated in FIG. 3, to provide a selected degree of filtration of the water or other liquid flowing through the filter screen 2 and the filter medium 13, into the pump suction openings 19. Typically, the filter medium 13 may be pre-formed in a cylindrical shape having a filter medium wall 14 and a filter medium bore 15 of selected dimensions, as further illustrated in FIG. 3. However, it will be understood according to the knowledge of those skilled in the art that other types of filter medium 13 may be provided, including filter medium of various design and characteristics which can be simply packed or positioned between the filter screen 2 and the pump suction openings 19 without pre-forming the filter medium into the cylindrical shape illustrated in FIG. 3.

It will be further appreciated by those skilled in the art that the removable submersible pump filter 1 of this invention is characterized by convenience and flexibility, in that it can be sized to fit substantially any pump housing 18 of a submersible pump 17 of selected design. Moreover, the filter screen 2 can be designed with a screen mesh 3 of sufficient size to filter substantially any contaminants, including debris, sand and the like, in non-exclusive particular, from the water or other liquid flowing through the screen mesh 3 in the filter screen 2, into the pump suction openings 19. Under circumstances where the quality of the filtered water or other liquid effluent discharged from the pump discharge 20 of the submersible pump 17 must be high, a filter medium 13 of selected design may include such materials as carbon, and the like, inserted between the filter screen 2 and the pump suction openings 19 for the purpose.

While the preferred embodiments of the invention have been described above, it will be recognized and understood that various modifications may be made in the invention, and the appended claims are intended to cover all such modifications which may fall within the spirit and scope of the invention.

Having described my invention with the particularity set forth above, what is claimed is:

1. A removable submersible pump filter for mounting on the pump housing of a submersible pump at the pump housing liquid intake, comprising a cylindrical screen sized to fit the pump housing and a pair of split collars engaging said screen and the pump housing for removably securing said screen on the pump housing.

2. The removable submersible pump filter of claim 1 comprising a fastener engaging each of said split collars for tightening said split collars and said screen on the pump housing.

3. The removable submersible pump filter of claim 2 comprising an opening provided in said split collars and wherein said fastener comprises a bolt extending through said opening and a nut threaded on said bolt for tightening said bolt and said split collars, respectively.

4. The removable submersible pump filter of claim 1 comprising a filter medium disposed between said screen and the pump housing for filtering liquid or flowing through said screen and said filter medium into the pump housing liquid intake of the pump housing.

5. The removable submersible pump filter of claim 4 comprising a fastener engaging each of said split collars for tightening said split collars and said screen on the pump housing.

6. The removable submersible pump filter of claim 5 comprising an opening provided in said split collars and wherein said fastener comprises a bolt extending through said opening and a nut threaded on said bolt for tightening said bolt and said split collars, respectively.

7. A removable submersible pump filter for mounting on the pump housing of a submersible pump at the pump suction openings and filtering a liquid flowing into the pump suction openings, comprising a cylindrical screen sized to fit the pump housing, a pair of split collars engaging said screen and the pump housing and a fastener engaging each of said split collars for selectively tightening and loosening said split collars and removably securing said screen on the pump housing.

8. The removable submersible pump filter of claim 7 comprising an opening provided in said split collars and wherein said fastener comprises a bolt extending through said opening and a nut threaded on said bolt for tightening said bolt and said split collars, respectively.

9. The removable submersible pump filter of claim 7 comprising a filter medium disposed between said screen and the pump housing for further filtering the liquid flowing through said screen and said filter medium into the pump suction openings of the pump housing.

10. The removable submersible pump filter of claim 9 comprising an opening provided in said split collars and wherein said fastener comprises a bolt extending through said opening and a nut threaded on said bolt for tightening said bolt and said split collars, respectively.

11. The removable submersible pump filter of claim 7 comprising a generally cylindrical filter medium interposed between said screen and the pump suction openings of the pump housing for further filtering the liquid flowing through said screen and into the pump suction openings of the pump housing.

12. The removable submersible pump filter of claim 11 comprising an opening provided in said split collars and wherein said fastener comprises a bolt extending through said opening and a nut threaded on said bolt for tightening said bolt and said split collars, respectively.

13. A removable submersible pump filter for mounting on the pump housing of a submersible pump at the pump suction openings and filtering a liquid flowing into the pump suction openings, comprising a cylindrical screen sized to fit the pump housing, a pair of split collars engaging said screen and the pump housing, and a filter medium disposed between said screen and the pump housing for further filtering the liquid flowing through said screen and said filter medium into the pump suction openings of the pump housing.

14. The removable submersible pump filter of claim 13 wherein said filter medium is characterized by a generally cylindrical filter medium.

15. The removable submersible pump filter of claim 13 comprising an opening provided in said split collars and wherein said fastener comprises a bolt extending through said opening and a nut threaded on said bolt for tightening said bolt and said split collars, respectively.

16. The removable submersible pump filter of claim 15 wherein said filter medium is characterized by a generally cylindrical filter medium.
